(19) United States
(12) Patent Application Publication
(10) Pub. No.: US 2013/0339749 A1
(43) Pub. Date: Dec. 19, 2013

(54) DISTRIBUTED BIOMETRIC DATA STORAGE AND VALIDATION

(71) Applicants: Philippe Spuehier, Rossens (CH); Urs Schmied, Murien (CH); Adrian Schuepbach, Neuenega (CH)

(72) Inventors: Philippe Spuehier, Rossens (CH); Urs Schmied, Murien (CH); Adrian Schuepbach, Neuenega (CH)

(21) Appl. No.: 13/536,063

(22) Filed: Jun. 28, 2012

Related U.S. Application Data
(60) Provisional application No. 61/664,434, filed on Jun. 26, 2012.
(60) Provisional application No. 61/661,434, filed on Jun. 19, 2012.

(51) Int. Cl. G06F 21/32

(52) U.S. Cl. CPC G06F 21/32
USPC 713/186

(57) ABSTRACT

Systems and methods for securely storing biometric data for use in a biometric identification system, and accessing such data for validating individuals, are described. One method of securely storing biometric data for use in a biometric identification system includes receiving a template describing biometric data that identifies a person. The method also includes encrypting the template using an encryption key, and separating the encrypted template into at least first and second portions, wherein both the first portion and the second portion are required to reconstruct the template. The method also includes storing the first portion in a database and storing the second portion on an access device issued to the person.

### CROSS-REFERENCE TO RELATED APPLICATIONS

The present application claims priority to U.S. Provisional Patent Application No. 61/664,434, filed on Jun. 19, 2012, the disclosure of which is hereby incorporated by reference in its entirety.

### TECHNICAL FIELD

The present application relates generally to biometric solutions. In particular, the present application relates to a distributed biometric data storage and validation system, and associated methods of storage and validation.

### BACKGROUND

In the area of biometric solutions, the stored data defining a fingerprint, an iris, hand-veins, or any other biometric feature is specified in the form of a biometric template. In general, the biometric template, or template, is a digital reference of distinct characteristics that are extracted from a biometric sample. For example, a template may be a digital representation of a particular person's fingerprint, iris, voice, or other identifiable biometric characteristic.

Increasingly, biometric information is used to validate the identity of individuals in a variety of contexts. For example, it can be used in access control systems, to ensure that only authorized individuals are allowed to access various locations in a facility. It can also be used in other scenarios in which personal validation is required, such as prior to release of confidential information, or in other applications.

When a person is initially allowed access to a particular resource protected using biometric access controls, that person typically must go through an enrollment process, in which the template of a person is usually generated and stored. Typically, the template could be stored in one piece in a central database or on a device such as USB stick, smartcard or any other device. However, each of these options has disadvantages. For example, the file size of the template is usually too large to be stored on contactless cards or other tokens. Second, even if the memory of such a card were designed to be sufficiently large, the data communication speed between a contactless smartcard and associated reader typically means that it would take too long to read the template during a verification process. On the other hand, if the templates are stored in a central database, the problem of reading speed is resolved, but the database is not under control of the person whose biometric data is described. This implicates data privacy issues, since a person may not wish a company to retain that person's template after they leave the company, but would have no way to control the biometric data once it is, as a whole, outside of their control.

For these and other reasons, improvements are desirable.

### SUMMARY

In accordance with the following disclosure, the above and other issues are addressed by the following:

In a first aspect, a method of securely storing biometric data for use in a biometric identification system is disclosed. The method includes receiving a template describing biometric data that identifies a person, and encrypting the template using an encryption key. The method also includes separating the encrypted template into at least first and second portions, wherein both the first portion and the second portion are required to reconstruct the template. The method further includes storing the first portion in a database, and storing the second portion on an access device issued to the person.

In a second aspect, a method of validating biometric data of a person is disclosed. The method includes receiving from a biometric reader a template describing biometric data that identifies a person, and receiving from an access device reader a first encrypted portion of a stored template. The method further includes retrieving a second encrypted portion of the stored template from a database, and combining the first and second encrypted portions to form an encrypted stored template. The method includes decrypting the encrypted stored template to obtain the stored template and comparing the template to the stored template to validate the person.

In a third aspect, a biometric identification system is disclosed. The biometric identification system includes a biometric reader, an access device reader, a database, and a computing system. The biometric reader is configured to receive biometric data from a person and convert the biometric data to a current template that identifies a person. The access device reader is configured to receive data from an access device, the data including a first encrypted portion of a previously-stored template associated with the person and a key. The database is configured to store a plurality of second encrypted portions of previously-stored templates, the plurality of second encrypted portions including a second encrypted portion associated with the first encrypted portion and the person. The computing system is communicatively connected to the biometric reader, access device reader, and the database. The computing system is configured to combine the first and second encrypted portions, forming an encrypted template, decrypt the encrypted template to form a restored template, and compare the restored template to the current template to validate the person.

### BRIEF DESCRIPTION OF THE DRAWINGS

FIG. 1 is a schematic view of an example biometric identification system, in which aspects of the present disclosure can be implemented;

FIG. 2 illustrates a logical diagram of distributed, securely stored biometric data, useable in a biometric identification system according to an example embodiment of the present disclosure;

FIG. 3 illustrates a logical diagram representing reconstitution of distributed and securely stored biometric data, useable in a biometric identification system according to an example embodiment of the present disclosure;

FIG. 4 is a flowchart of a method for securely storing biometric data for use in a biometric identification system, according to an example embodiment;

FIG. 5 is a flowchart of a method for validating biometric data of a person, according to an example embodiment; and

FIG. 6 is a block diagram of an electronic computing device in which aspects of the present disclosure can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for providing distributed storage and validation of biometric data. The systems and methods described herein can be used in a variety of applications, such as access control, identification, or other applications. Generally, the distributed biometric data provides a portion of the biometric data, in encrypted form, to each of the person with whom it is associated and the entity with which that person wishes to validate his/her identity. This allows the person with whom the biometric data is associated to control ownership of the biometric data, while minimizing the storage requirements on access devices that the person would carry, and also providing the entity with centralized person management. Namely, each of the person and the access-granting organization has the ability to destroy a portion of the stored reference biometric data, rendering the remaining portion held by the other party effectively useless, and therefore effectively removing the ability for the entity to validate the person's identity.

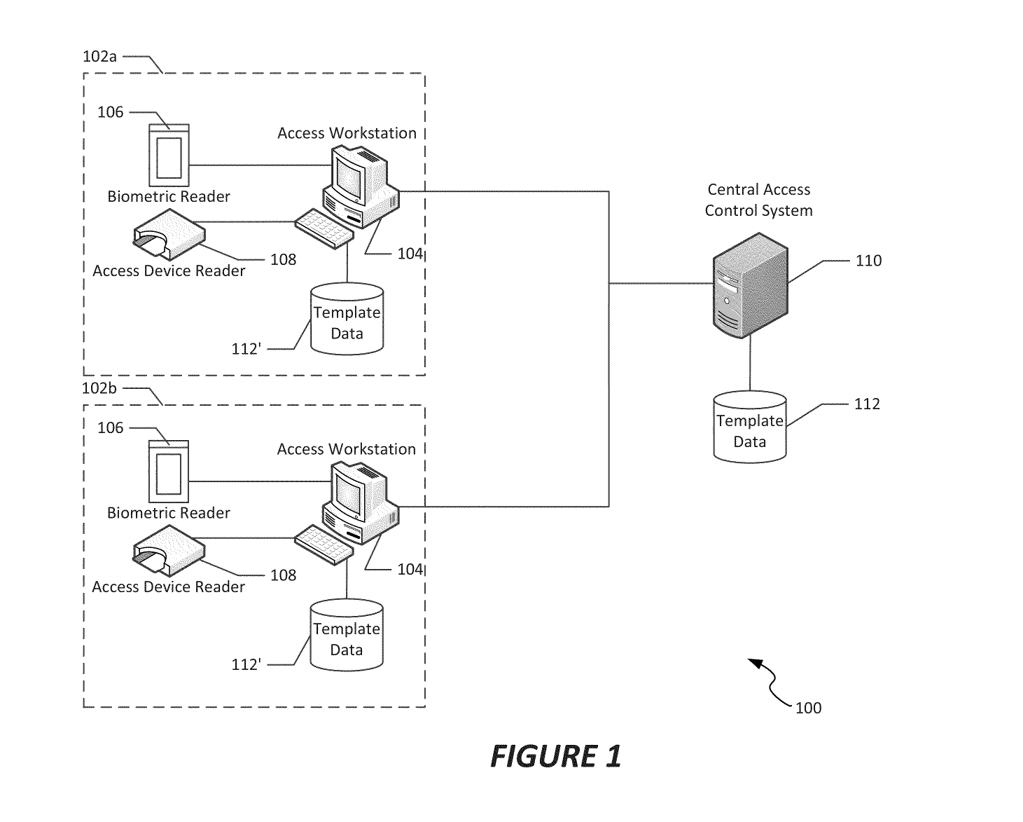

Referring now to FIG. 1, an example biometric identification system 100 is disclosed in which aspects of the present disclosure can be implemented. The biometric identification system 100 can be implemented, for example, at a facility or other location where access to resources, such as people, information, or restricted-access locations, are to be controlled. In the example illustrated, the system 100 is configured to include identification verification subsystems at first and second locations 102a-b; however, it is understood that in varying embodiments, one or three or more of such locations can be included.

In the embodiment shown, each of the locations 102a-b generally has an access workstation 104. Each access workstation 104 is communicatively connected to a biometric reader 106 and an access device reader 108. The biometric reader 106 can be any of a variety of types of devices configured to capture biometric data and store that biometric data in a digitized format, referred to above as a biometric template, or simply a template. In various embodiments, the biometric reader 106 can be a fingerprint reader, hand-vein reader, iris scanner, retina scanner, or a voice or facial recognition device. Other options are available as well.

The access device reader 108 can be configured to communicate with any of a variety of types of access devices, depending upon the type of access device selected for distribution to preauthorized individuals to use when attempting to be validated. In various embodiments, the access devices useable in connection with the access device reader can be, for example, a contactless or contact access card, a multi-interface card, a mobile phone, a USB stick-type memory device, or any other generally handheld-sized device having a memory. Accordingly the access device reader 108 could be any of a contactless access card reader, a contact card reader, a multi-interface card reader, an RFID reader, barcode reader, or a computing system having a communication port. Other options are available as well.

It is noted that, although in FIG. 1 the access workstation 104 is illustrated as a desktop computing system, in various embodiments the workstation can take any of a number of forms. For example, in some embodiments, the access workstation 104 is implemented as a microcontroller integrated within one or both of the biometric reader and/or the access device reader 108. In addition, in some embodiments, the functionality of the access workstation 104, the biometric reader 106, and the access device reader 108 can be integrated into a single device.

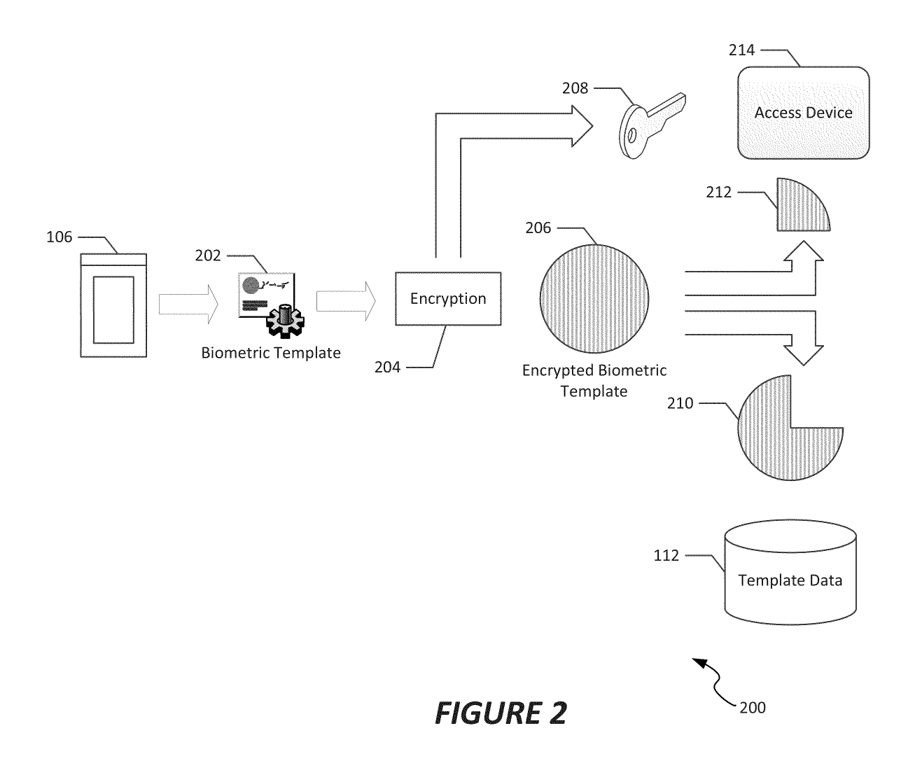

In the embodiment shown, the access workstations 104 at each location 102a-b are connected to an access control server 110, which hosts a database 112. In general, the access control server 110 receives requests from each of the access workstations 104, and provides data in return that assists in validating persons who provide both biometric data and data from an access device at a validation location. In some embodiments, the validation can occur at the access control server, while in other embodiments, the validation can occur at the access workstation at which validation is sought. The database 112 stores data managed by the entity controlling the validation process (i.e., the entity controlling access to the resource), which is required for validation of persons seeking validation. As discussed in further detail in connection with FIGS. 2-5, below, in some embodiments, the data can include a portion of an encrypted template for each person, which can be used to reconstruct (with other data received from the access device) a “stored” template, meaning a template captured at the time the person registers for access/validation rights, and which can be compared against a current template, or a template captured at the time validation is sought.

It is noted that, in some embodiments, the database 112 or some portion thereof can also be stored at the various access workstations 104. In such embodiments, each of the access workstations 104 can, based on data captured from an associated biometric reader 106 and access device reader 108, independently validate a person using data stored in such distributed databases 112′ hosted at the access workstations 104. In such embodiments, the database 112, and associated distributed databases 112′, can be periodically synchronized (e.g., once every predetermined number of minutes) to ensure that a person whose data has been added to or removed from the database 112 (and therefore whose validation rights have changed) remains accurate across all databases.

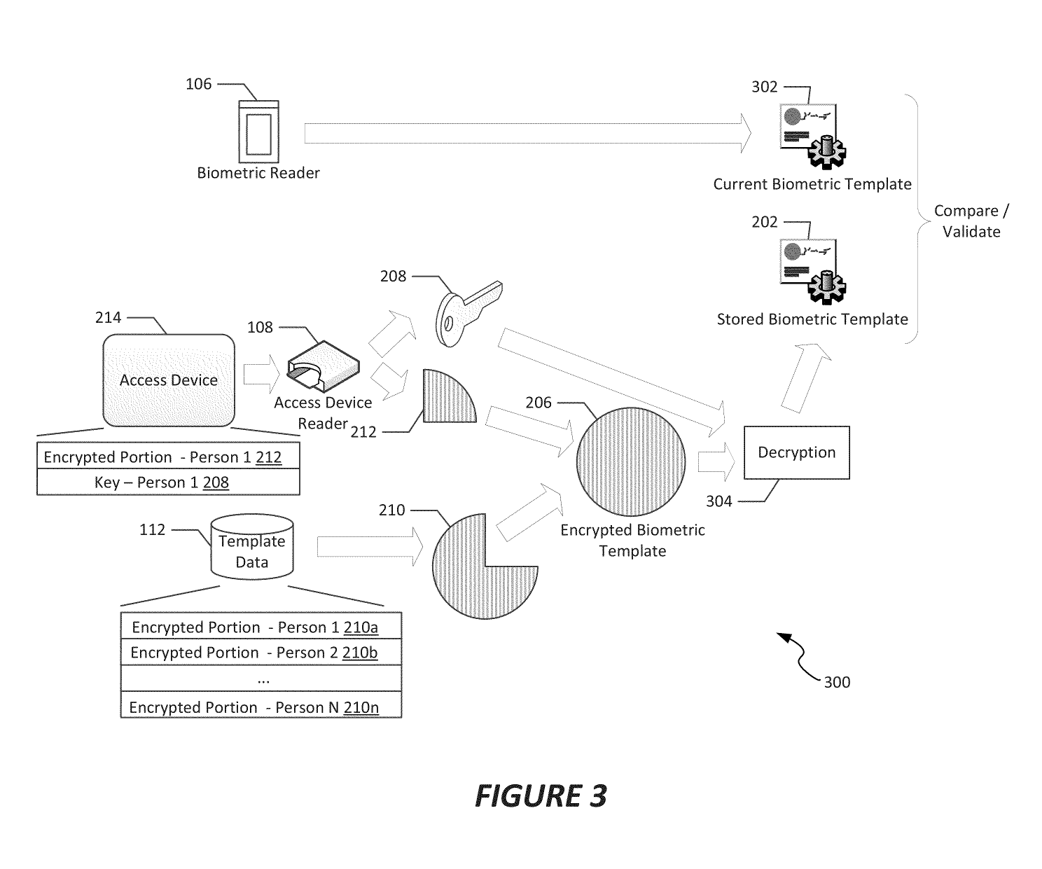

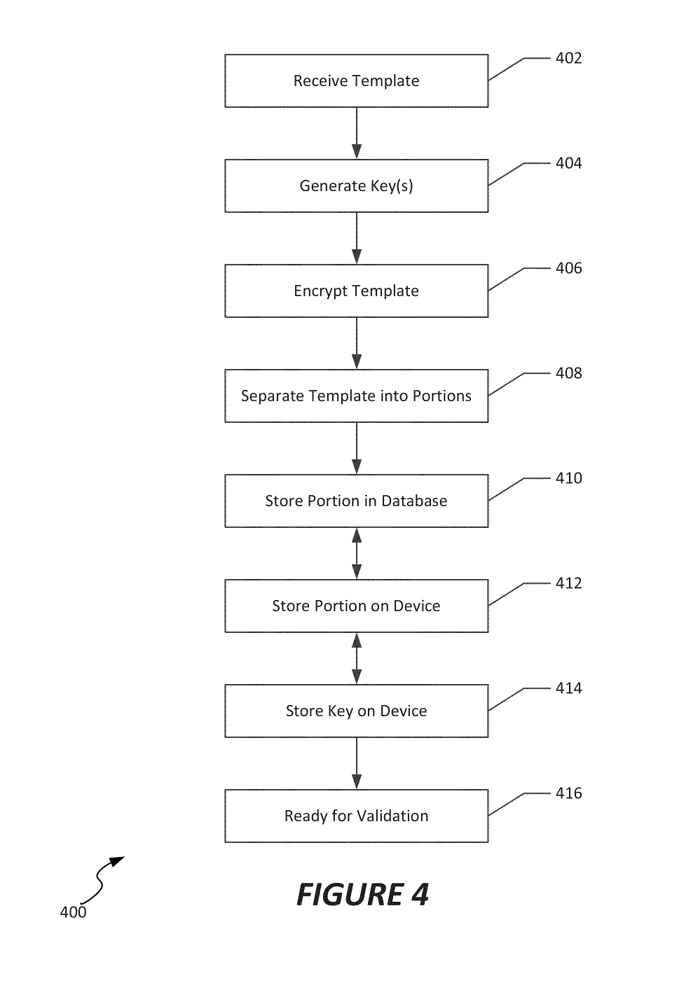

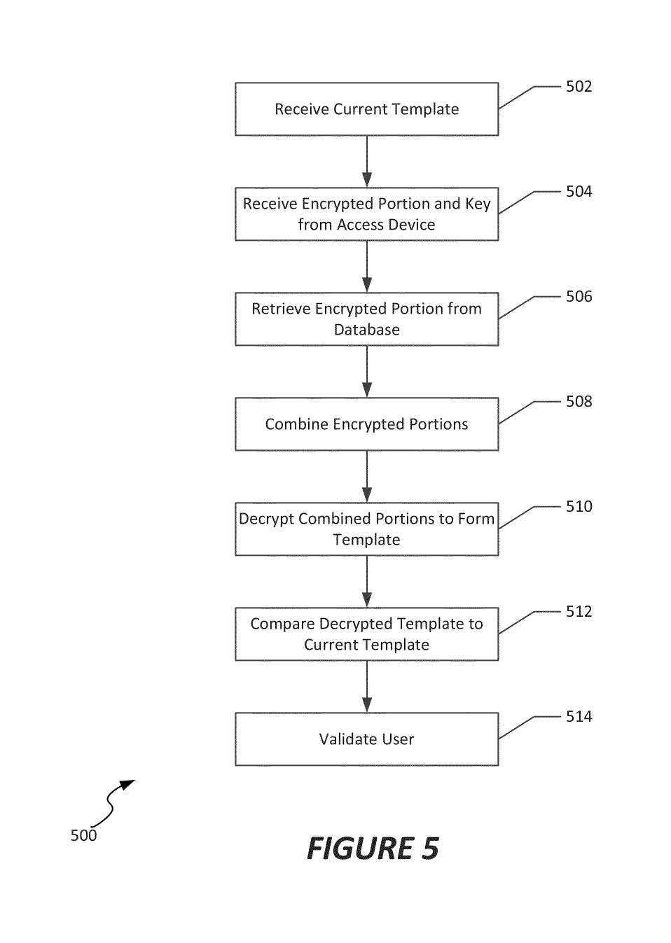

In still further embodiments, the access control server 110 can correspond to or be distributed across multiple physical computing devices, either within or external to an organization at which access control or identification processes as discussed herein are to be implemented. Referring now to FIGS. 2-5, logical diagrams and flowcharts illustrating registration with and validation of a person using distributed, securely stored biometric data is illustrated. FIGS. 2-3 illustrate data transformations, storage, and validation of persons occurring within a biometric identification system, such as system 100 of FIG. 1. FIGS. 4-5 represent methods performed within such a system for registering and validating people, using the data transformations and storage techniques of FIGS. 2-3.

Referring now to FIG. 2, a logical diagram 200 of distributed, securely stored biometric data, useable in a biometric identification system, is shown. The diagram 200 generally illustrates data transformations that will occur based on captured biometric data for future validation of the same person. In the embodiment shown, a person wishing to register with a system has his or her biometric data captured by a biometric device 106, which can be any of a variety of types of devices as previously described. The biometric device generates a biometric template 202, also referred to as a template, which represents a digitization of the biometric data in a manner that can be distinguished from others' biometric data, but which can also be used for comparison purposes in future validation processes.

In the embodiment shown, the template 202 is passed through an encryption algorithm 204. The encryption algorithm can be any of a variety of encryption algorithms capable of two-way (reversible) encryption of data. In an example embodiment AES-256-based encryption is used; however, in alternative embodiments, other encryption standards can be used as well. This results in creation of an encrypted biometric template 206, which has an associated key 208. In various embodiments, the associated key 208 can be a symmetric key or a decrypting portion of an asymmetric key pair, such as a private key of a public/private key pair.

The encrypted template 206 is then split into at least two parts, shown as a first part 210 and a second part 212. The first and second parts 210, 212 of the encrypted template 206 can be separated in any of a variety of ways; however, in general the separation is performed such that the parts can be matched to each other and the encrypted biometric template can be reconstituted. For example, in some cases, each of the first and second parts 210, 212 can be associated with a common identifier, such as the key used to generate the encrypted template 206; other methods of linking the parts are possible as well. However, in general the first and second parts 210, 212 of the encrypted template 206 are stored in different locations. In the embodiment shown, the first part 210 is stored in a database 112 containing template data from various people who are able to be validated by the system 100.

The second part 212 is stored, alongside the decryption key 208, on an access device 214. The access device 214 is generally any type of device capable of storing data, and useable for convenient access to resources. Typical access device types can include a contactless or contact access card, a multi-interface card, a mobile phone or other mobile computing device, or a USB stick-type memory device.

Once the key 208 and second portion 212 are stored on the access device 214 and the first portion 210 is stored in database 112, the person can subsequently be validated and provided access to a desired resource, as needed. To accomplish such validation, the person will present both biometric data and an access device at a validation location. By presenting both biometric data and the access device, a high degree of reliability is provided that the person being validated is in fact the correct individual, since they both possess the correct access device and have biometric characteristics that match those of a stored template. As illustrated in the logical diagram 300 of FIG. 3, at the time a person wishes to be validated, that person presents an access device 214 to an access device reader 108, and allows biometric data to be captured. The biometric data captured at the time of validation, i.e., “current” biometric data, is stored in a current biometric template 302. Also at the time of validation, the person will scan his/her access device, and communicate data stored on that access device 214 to an access device reader 108.

In the embodiment shown, the data on the access device 214, including the key 208 and the second encrypted portion 212 of the encrypted template (stored at the time the person was registered), are received at the access device reader 214, which passes that data to the access workstation 104 and/or the access control server 110. Based on an identification of the person based on that data from the access device 214, the database 112 is accessed, and a complementary encrypted portion 210 is retrieved from the database, from among a collection of portions of encrypted data (seen as encrypted portions 210a-n). The encrypted template 206 is then reconstituted from the encrypted portions 210, 212, and passed to a decryption module 304. The decryption module receives the key 208 that was retrieved from the access device 214, and decrypts the encrypted template 206, thereby reforming the stored biometric template 202. This previously-stored biometric template 202, captured at the time the person registers with the system 100, can be compared to the current biometric template 302. If the templates 202, 302 match to at least a predetermined degree, the person is determined to be validated.

In FIGS. 2-3, it is noted that the first and second portions 210, 212 can be any of a variety of sizes. In some embodiments, it is desirable to ensure that the second portion 212 (i.e., the portion stored on the access device 214) is relatively smaller than the portion 210 stored in the database 112. This is because, in the case of contactless access cards or other access methods involving wireless proximity-based communication, the communication speeds between the access device 214 and the access device reader 18 may be slow, and may therefore require the person wishing to be validated to hold the device 214 in proximity to the reader 108 for a substantial amount of time. To avoid this issue, in some embodiments, although typical biometric templates, and in particular encrypted templates (such as encrypted template 206) can exceed 100 kilobytes in size, the portion 212 stored on the access device 214 may be limited to one kilobyte or less, thereby ensuring that the time required for reliable communication of the portion 212 and the key 208 remains short (e.g., 100-200 milliseconds).

Referring now to FIGS. 4-5, methods for securely storing and validating biometric data are described, and which are useable in a biometric identification system such as the system 100 of FIG. 1. The methods described herein can be performed, for example, within one or both of an access workstation 104, or the access control server 110, or other distributed computing systems as may be desired, and generally accomplish the data transformations illustrated in FIGS. 2-3, respectively, which were described above.

In FIG. 4, a method 400 of securely storing biometric data is instantiated by receipt of a template 202 from a person wishing his or her biometric data to be stored (step 402). One or more keys can be created or obtained, including a key 208 capable of use in decrypting an encrypted template, as well as either the same key or a different key useable to encrypt the template 202 (step 404). In accordance with the present disclosure, the generated key can be a symmetric key used for encryption and decryption, or can be one of an asymmetric key pair, such as a public-private key pair. The template is encrypted, for example using either a symmetric key or an asymmetric key such as a public key of a public/private key pair, which is generated or obtained in step 404, at an encryption module 204 (step 406). This encrypted template 206 is then split into portions 210, 212 (step 408), with a first portion being stored in database 112 (step 410) and a second portion stored on an access device 214 (step 412). A key is also stored on the access device 214 (step 414). At this point, the biometric data associated with that person is in place, and ready for subsequent validation, as may be required to provide access to that person to a particular resource (step 416).

In FIG. 5, a method 500 for validating biometric data of a person is illustrated, which may be performed for any user who has previously been registered for access, for example using the method 400 of FIG. 4, and data transformations illustrated in FIG. 2. The method 500 can be used to perform the data transformations illustrated in FIG. 3, to accomplish validation of a person and accordingly to provide access to resources as needed.

In the embodiment shown, the method is initiated once a computing system receives from a biometric reader a current template 302 representing biometric data of the person (step 502). At approximately the same time as this (i.e., within the same validation process), the computing system receives an encrypted portion 212 of a previously-stored template, as well as a key 208, that were stored on an access device 214 (step 504). Based on the received encrypted portion 212 and/or the key 208, a database 112 is accessed (e.g., either database 112′ local to access workstation 104, or database 112 hosted by the access control server 110), and a remaining encrypted portion 210 is retrieved (step 506). The computing system then combines the portions 210, 212 to recreate the encrypted template 206, which was originally generated in step 406 of FIG. 4 (step 508). The encrypted template 206 is then decrypted using the key 208 (e.g., by decryption module 304 of FIG. 3) to form the previously-stored template 202 (step 510). The previously-stored template 202 is then compared to the current template 302, as captured from the to-be-validated person, to determine if that person is in fact the individual having matching biometric characteristics (step 512). Upon a determination that the templates match (at least within a predetermined level of accuracy), the user is validated, and can be allowed to access a resource being protected using the systems of the present disclosure (step 514). In various embodiments, the validation step can be performed in a variety of ways, for example by unlocking a door, transmitting an “approved” message to a remote system, or otherwise indicating that the biometric data, as represented by templates 202, 302, correlate to each other. Referring now to FIGS. 4-5, it is recognized that although a particular order of operations is illustrated in these methods, other orders of the steps within a particular method may be possible. That is, although a person must generally be registered for validation prior to validation, there is no requirement as to the order in which that user presents his/her validation information. For example, a person seeking validation may present his/her biometric information to a biometric reader prior to or after scanning an access card or other access device; similarly, the order in which data is stored in the database 112 and on an access device 214 as mentioned in FIG. 4 is largely a matter of implementation choice. Other orders of steps could be provided within different embodiments as well.

Referring to FIGS. 1-5 generally, it is noted that three separate components are required to be present to validate a person who is preregistered with such an identification system. That is, the person must provide current biometric data and a portion of the previously-captured biometric data, and the organization or facility providing the identification system must provide another portion of the previously—captured biometric data. If any of these components is not present, validation of the person's identification is not possible. This allows for a number of features of the present system and methods, to prevent unauthorized access to a resource, or incorrect use of biometric data. First, an imposter person cannot be validated, even if they possess the first and second portions of the previously-stored template, because they cannot provide the current biometric data needed to generate the current template 302 of FIG. 3. Second, a person cannot be properly access a resource after the portion 210 of the template associated with that person has been removed from the database 112, since both portions 210, 212 are required to recreate the stored template 202 used for comparison to the current biometric template 302. Finally, if the person wishes to discontinue accessing resources controlled with the system 100, that person simply can discard the access device 214, since without the access device, the organization maintaining the database 112 cannot do anything with the second part 212 associated with that person, because it is encrypted with a key not possessed by the organization, and can only be reconstructed when used in combination with a first part 210 which is also not available to the organization (even if that organization retains a copy of the key). As such, using the systems and methods for storing and validating distributed biometric data provides enhanced security, while ensuring that the individuals uniquely associated with biometric data can control its distribution.

A still further advantage of the present disclosure relates to the case of a lost access device. In this case, since the person requiring access no longer possesses the device, there is no worry that the device can be used for another individual to access any resources in an unauthorized manner. The person can, if access or identification is still required, simply re-enroll by providing biometric data, and the systems discussed herein can re-create portions 210, 212 of that data using a new key or key pair, thereby obsoleting the previously-created portion 210 in the database 112. In such embodiments, old portions that have not been used for identification/validation processes can periodically be removed from the database 112 (e.g., on an annual or other periodic basis). Other advantages of the present disclosure are apparent as well, from the above description and as recited in the following claims.

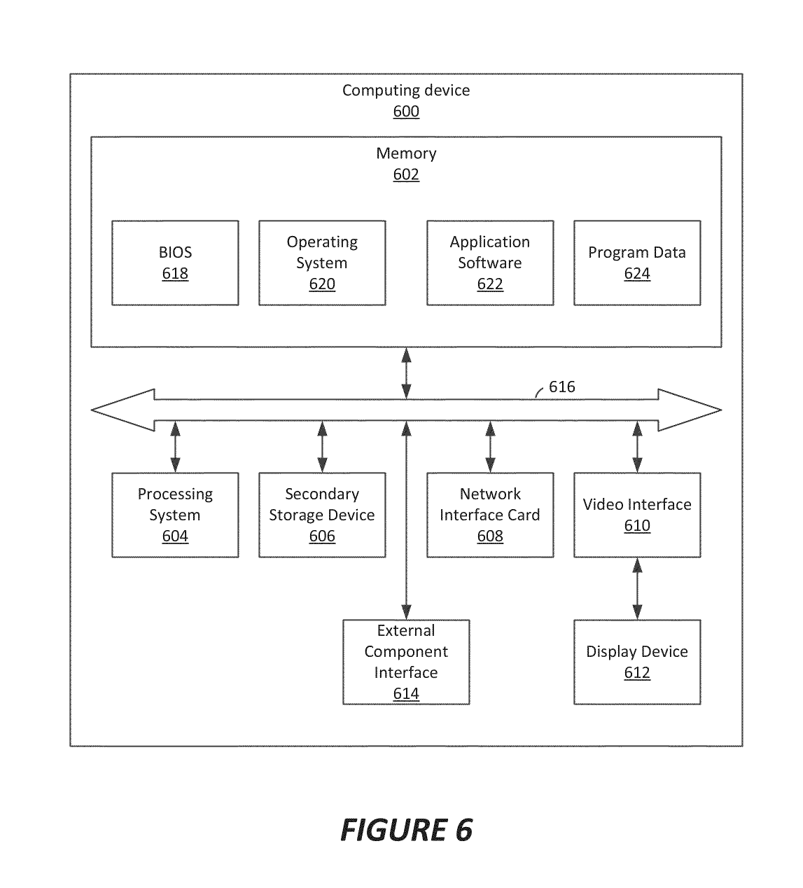

Referring now to FIG. 6, a block diagram illustrating an example computing device 600 is shown, which can be used to implement aspects of the present disclosure. In particular, the computing device 600 can represent a server or computing device within an organization useable to configure parameters to be included in, or to execute, a business continuity plan. For example, the computing device 600 can correspond to or be incorporated with any of the devices 104, 110 of FIG. 1, above, and can host execution of software for performing any of the methods or implementing any of the systems described in FIGS. 1-5, above.

In the example of FIG. 6, the computing device 600 includes a memory 602, a processing system 604, a secondary storage device 606, a network interface card 608, a video interface 610, a display unit 612, an external component interface 614, and a communication medium 616. The memory 602 includes one or more computer storage media capable of storing data and/or instructions. In different embodiments, the memory 602 is implemented in different ways. For example, the memory 602 can be implemented using various types of computer storage media.

The processing system 604 includes one or more processing units. A processing unit is a physical device or article of manufacture comprising one or more integrated circuits that selectively execute software instructions. In various embodiments, the processing system 604 is implemented in various ways. For example, the processing system 604 can be implemented as one or more processing cores. In another example, the processing system 604 can include one or more separate microprocessors. In yet another example embodiment, the processing system 604 can include an application-specific integrated circuit (ASIC) that provides specific functionality. In yet another example, the processing system 604 provides specific functionality by using an ASIC and by executing computer-executable instructions.

The secondary storage device 606 includes one or more computer storage media. The secondary storage device 606 stores data and software instructions not directly accessible by the processing system 604. In other words, the processing system 604 performs an I/O operation to retrieve data and/or software instructions from the secondary storage device 606. In various embodiments, the secondary storage device 606 includes various types of computer storage media. For example, the secondary storage device 606 can include one or more magnetic disks, magnetic tape drives, optical discs, solid state memory devices, and/or other types of computer storage media.

The network interface card 608 enables the computing device 600 to send data to and receive data from a communication network. In different embodiments, the network interface card 608 is implemented in different ways. For example, the network interface card 608 can be implemented as an Ethernet interface, a token-ring network interface, a fiber optic network interface, a wireless network interface (e.g., Wi-Fi, WiMax, etc.), or another type of network interface.

The video interface 610 enables the computing device 600 to output video information to the display unit 612. The display unit 612 can be various types of devices for displaying video information, such as a cathode-ray tube display, an LCD display panel, a plasma screen display panel, a touch-sensitive display panel, an LED screen, or a projector. The video interface 610 can communicate with the display unit 612 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 614 enables the computing device 600 to communicate with external devices. For example, the external component interface 614 can be a USB interface, a FireWire interface, a serial port interface, a parallel port interface, a PS/2 interface, and/or another type of interface that enables the computing device 600 to communicate with external devices. In various embodiments, the external component interface 614 enables the computing device 600 to communicate with various external components, such as external storage devices, input devices, speakers, modems, media player docks, other computing devices, scanners, digital cameras, and fingerprint readers.

The communications medium 616 facilitates communication among the hardware components of the computing device 600. In the example of FIG. 6, the communications medium 616 facilitates communication among the memory 602, the processing system 604, the secondary storage device 606, the network interface card 608, the video interface 610, and the external component interface 614. The communications medium 616 can be implemented in various ways. For example, the communications medium 616 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 602 stores various types of data and/or software instructions. For instance, in the example of FIG. 6, the memory 602 stores a Basic

Input/Output System (BIOS) 618 and an operating system 620. The BIOS 618 includes a set of computer-executable instructions that, when executed by the processing system 604, cause the computing device 600 to boot up. The operating system 620 includes a set of computer-executable instructions that, when executed by the processing system 604, cause the computing device 600 to provide an operating system that coordinates the activities and sharing of resources of the computing device 600. Furthermore, the memory 602 stores application software 622. The application software 622 includes computer-executable instructions, that when executed by the processing system 604, cause the computing device 600 to provide one or more applications. The memory 602 also stores program data 624. The program data 624 is data used by programs that execute on the computing device 600.

Although particular features are discussed herein as included within an electronic computing device 600, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally excludes transitory wired or wireless signals. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The above specification, examples and data provide a complete description of the manufacture and use of the composition of the invention. Since many embodiments of the invention can be made without departing from the spirit and scope of the invention, the invention resides in the claims hereinafter appended.

1. A method of securely storing biometric data for use in a biometric identification system, the method comprising:
receiving a template describing biometric data that identifies a person;
encrypting the template using an encryption key;
separating the encrypted template into at least first and second portions, wherein both the first portion and the second portion are required to reconstruct the template;
storing the first portion in a database; and
storing the second portion on an access device issued to the person.

2. The method of claim 1, further comprising capturing the biometric data from the person and storing the biometric data in the template.

3. The method of claim 1, wherein encrypting the template comprises applying AES-256 encryption to the template.

4. The method of claim 1, wherein the access device comprises a contactless access card having a memory.

5. The method of claim 4, wherein the encrypted template has a file size of over about 100 kB, and the second portion has a size less than about 1 kB.

6. The method of claim 1, further comprising storing a key on the access device capable of use in decrypting the encrypted template.

7. The method of claim 1, wherein receiving the template occurs upon the person attempting to access a facility.

8. The method of claim 7, wherein the database is associated with an entity that controls access to a facility.

9. The method of claim 1, further comprising:
receiving from a biometric reader a second template;
receiving the second portion and a key from an access device reader;
retrieving the first portion from the database;
combining the first and second portions to reform the encrypted template;
decrypting the encrypted template to obtain a stored version of the template; and
comparing the second template to the stored version of the template to validate the person.

10. A method of validating biometric data of a person, the method comprising:
receiving from a biometric reader a template describing biometric data that identifies a person;
receiving from an access device reader a first encrypted portion of a stored template;
retrieving a second encrypted portion of the stored template from a database;
combining the first and second encrypted portions to form an encrypted stored template;
decrypting the encrypted stored template to obtain the stored template; and
comparing the template to the stored template to validate the person.

11. The method of claim 10, further comprising, upon determining that the template and the stored template correspond, generating a notification indicating that the person has been successfully validated.

12. The method of claim 10, wherein both the first encrypted portion and the second encrypted portion are required to reconstruct the encrypted stored template.

13. The method of claim 10, further comprising receiving a key from the access device reader.

14. The method of claim 13, wherein the key and the first encrypted portion are stored on an access device communicatively connectable to the access device reader.

15. A biometric identification system comprising:
a biometric reader configured to receive biometric data from a person and convert the biometric data to a current template that identifies a person;
an access device reader configured to receive data from an access device, the data including a first encrypted portion of a previously-stored template associated with the person and a key;
a database storing a plurality of second encrypted portions of previously-stored templates, the plurality of second encrypted portions including a second encrypted portion associated with the first encrypted portion and the person;
a computing system communicatively connected to the biometric reader, the access device reader, and the database, the computing system configured to:
combine the first and second encrypted portions, forming an encrypted template;
decrypt the encrypted template to form a restored template; and
compare the restored template to the current template to validate the person.

16. The system of claim 1, wherein the biometric data is selected from a group of possible types of biometric data consisting of:
fingerprint data;
iris scan data;
retina scan data;
hand-vein scan data;
voice recognition data; and
facial recognition data.

17. The method of claim 15, wherein the access device reader is selected from a group of possible access devices consisting of:
a contactless access card reader;
a contact card reader;
a bar code reader;
an RFID reader;
a multi-interface card reader; and
a computing system having a communication port.

18. The system of claim 15, wherein the access device is selected from a group of possible access devices consisting of:
a contactless access card;
a contact card;
a mobile phone;
a multi-interface card; and
a USB-flash drive device.

19. The system of claim 15, wherein the biometric reader and the access device reader are positioned at an entrance to a facility.

20. The system of claim 19, further comprising a plurality of biometric readers and a plurality of access device readers dispersed through a facility, wherein each of a plurality of locations at the facility includes a biometric reader and an access device reader.

21. The system of claim 20, wherein the computing system is communicatively connected to each of the plurality of biometric readers and the plurality of access card readers, and wherein the computing system hosts the database.
